(19) United States
(12) Patent Application Publication
(10) Pub. No.: US 2012/0213599 A1
(43) Pub. Date: Aug. 23, 2012

(54) Web Floating and Conveying Device and Method of Manufacturing Same

(75) Inventors: Hiroshi Inazawa, Yamaguchi (JP); Go Fukui, Yamaguchi (JP); Kazuhide Ota, Yamaguchi (JP); Satoshi Kubo, Yamaguchi (JP); Takuji Nakamura, Yamaguchi (JP); Tadashi Fujii, Tokyo (JP)

(73) Assignee: TOYO KOHAN CO., LTD, Tokyo (JP)

(21) Appl. No.: 13/384,221

(22) PCT Filed: Mar. 29, 2010
(86) PCT No.: PCT/JP2010/002234

§ 371 Date: May 1, 2012

(30) Foreign Application Priority Data
Jul. 15, 2009 (JP) 2009-166504

(51) Int. Cl. B65G 51/02; B32B 37/16

(52) U.S. Cl. 406/88; 156/60

(57) ABSTRACT

Provided is a web floating and conveying device which has excellent web quality maintaining property and excellent conveying-fluid precision control property in conveying a web film. A conveyance guide (1) of the web floating and conveying device (10) is formed of a lamination-type assembled body having the split structure which is constituted of plate-shaped members (2) which are approximately radially arranged from an axis of the conveyance guide (1). A fluid passing passage which forms a fluid discharge hole by connecting a web floating surface (1a) and an introduction flow passage (7) through which a pressurized fluid is supplied to each other is formed on either one or both lamination surfaces of the plate-shaped members (2) which are laminated adjacent to each other.

### TECHNICAL FIELD

The present invention relates to a web floating and conveying device which conveys a web-film-shaped object (hereinafter referred to as “web”) such as a resin film while floating the web with a fluid, a method of manufacturing the web floating and conveying device, and a web conveying method.

The present invention particularly relates to a web floating and conveying device for an object which is softened at the time of heat treatment such as a thermoplastic resin film and a method of manufacturing the web floating and conveying device.

### BACKGROUND ART

Conventionally, there have been made various proposals with respect to a device which conveys an elongated film by floating using a fluid such as air.

For example, patent document 1 (JP-A-2000-16648) discloses an object floating device which conveys an object by floating the object with a fluid. The object floating device is a lamination type object floating device where a lamination surface is formed of a plurality of thin plates each of which has a first flow passage hole constituting a fluid passage for a fluid supplied from the outside, and the flow passage for the fluid is formed in the vicinity of the lamination surface. In such a method, the flow passage can take a large length/cross-sectional area ratio and hence, a floating height can be made small by making pipe passage resistance of a throttle large thus increasing a floating force.

Further, patent document 2 (JP-A-11-106110) discloses an assembly roll where a plurality of radial plates each of which is constituted of an outer edge portion which is brought into contact with an object to be conveyed such as an elongated sheet, an inner edge portion which is mounted on a rotary shaft which is rotatably driven by applying a predetermined adhesive agent by coating, and a connection portion which connects the outer edge portion and the inner edge portion to each other are radially arranged with respect to the rotary shaft thus forming a cylindrical body, wherein at least outer edge portions of the radiation plates and connection portions which are arranged adjacent to each other are arranged with predetermined gaps therebetween, and the gap between the outer edge portions opens in the outside.

### BACKGROUND ART DOCUMENT

### Patent Document

Patent document 1: JP-A-2000-16648

Patent document 2: JP-A-11-106110

### SUMMARY OF THE INVENTION

### Problems that the Invention is to Solve

However, in the lamination-type object floating device disclosed in patent document 1, the plurality of thin plates which form the lamination surface are laminated in the axial direction and hence, the flow passage can be arranged only at pitches of thin plates.

Accordingly, when such an object floating device is applied to stretching and drying steps of a thermoplastic resin film, the film is remarkably softened at the temperature of glass transition temperature Tg or above and hence, the film is gradually deformed in a shape which conforms to pitches of air discharge holes thus giving rise to a drawback that quality of a product is lowered.

Further, there exists a drawback that these deformations cause stripe-shaped defects in appearance on an optical film used in applications such as a liquid crystal display device leading to a fatal defect.

Further, in the assembly roll disclosed in patent document 2, the laminated bodies are radially arranged with respect to an axis of the assembly roll thus forming flow passages for a fluid in gaps formed between the inner edge portions and the outer edge portions respectively so that the assembly roll is applicable to a suction roll or the like.

However, when the assembly roll is used in the floating and conveying device, flow passages which are opened on a conveying surface are not formed independently and hence, a film floating amount is not stable. Accordingly, when a film is inclined with respect to the conveying surface or when a floating amount is increased or decreased in the widthwise direction, the structure is liable to enhance such a phenomenon and a function of adjusting a floating amount does not work thus giving rise to a drawback that the meandering of the film occurs when a tension of the film is small.

Further, in a case where a gap of the opening portion is made small so as to increase the pipe passage resistance, when a large-sized roll having a large width is used, accuracy in working or assembling the thin sheet is limited and hence, large and small irregularities occur with respect to a size of the gap of the opening portion thus giving rise to a drawback that a portion where the opening portion is locally large or a portion where the opening portion collapses is formed.

Accordingly, when such an assembly roll is applied to stretching and drying steps of a thermoplastic resin film, the meandering of the film occurs or, due to irregularities in film temperature attributed to non-uniformity of a discharge amount of air at the time of heat treatment, irregularities occur in the orientation direction or an orientation amount of molecules of the film thus giving rise to a drawback that a precise orientation control cannot be performed.

Particularly, with respect to an optical film which is used in a liquid crystal panel or the like, the irregularities in the orientation direction and the amount of orientation of molecules directly influence the optical birefringence so that a control of the molecular orientation is important.

Further, when the assembly roll is used at a high temperature, there arise many drawbacks including the insufficient durability of an adhesive agent and the irregularities in a change amount of an opening gap due to the thermal deformation of a thin plate cannot be ignored.

The present invention has been made to overcome the above-mentioned conventional drawbacks, and it is an object of the present invention to provide a web floating and conveying device which, in conveying a web such as a resin film, has excellent web quality maintaining property and excellent conveying-fluid precision control property without bringing about quality defects such as stripe-shaped defects of a web or the irregularities in the molecular orientation of a film caused by the arrangement of an opening position of a fluid discharge hole or a flow rate control.

It is another object of the present invention to provide a method of manufacturing a web floating and conveying device which realizes high assembling accuracy, can easily manufacture the web floating and conveying device, and has excellent economic property.

### MEANS FOR SOLVING THE PROBLEMS

(1) In a web floating and conveying device according to the present invention which includes a conveyance guide which has a cylindrically curved web floating surface, and conveys a web in a floating state by discharging a pressurized fluid from fluid discharge holes formed in the web floating surface, wherein the conveyance guide is formed of a lamination-type assembled body of plate-shaped members which are radially arranged with respect to an axis of the conveyance guide and form the cylindrically curved web floating surface, and

fluid passing passages which form the fluid discharge holes by connecting the web floating surface and an introduction flow passage through which the pressurized fluid is supplied to each other are formed on either one or both lamination surfaces of the plate-shaped members which are arranged adjacent to each other.

(2) In the web floating and conveying device having the above-mentioned constitution (1), the plate-shaped members are constituted of tapered members whose thickness is gradually increased toward the web floating surface from a side of the axis of the conveyance guide, and non-tapered members whose thickness is fixed, and

the conveyance guide is formed of a lamination-type assembled body of plate-shaped members which form the cylindrically curved web floating surface by radially arranging the tapered members and the non-tapered members with respect to the axis of the conveyance guide.

(3) In the web floating and conveying device having the above-mentioned constitution (1) or (2), a second plate-shaped member having a lamination surface on which fluid passing passages are not formed is sandwiched between the plate-shaped members.

(4) In the web floating and conveying device having the above-mentioned constitution (1) or (2), the fluid discharge holes form a plurality of rows of fluid discharge holes which are directed in the same direction as the axis of the conveyance guide, and the fluid discharge holes on the rows of fluid discharge holes which are arranged adjacent to each other are not arranged on the same line in the circumferential direction of the conveyance guide.

(5) In a method of manufacturing a web floating and conveying device of the present invention, which includes a conveyance guide which has a cylindrically curved web floating surface, and conveys a web in a floating state by discharging a pressurized fluid from fluid discharge holes formed in the web floating surface,

the conveyance guide is formed in such a manner that plate-shaped members each of which is formed of a tapered member which includes fluid passing passages which form the fluid discharge holes by connecting the web floating surface and an introduction flow passage through which the pressurized fluid is supplied to each other on either one of or both lamination surfaces and gradually increases a thickness thereof toward the web floating surface from an axis side of the conveyance guide are radially arranged and are laminated to each other with respect to an axis of the conveyance guide.

(6) In the method of manufacturing a web floating and conveying device having the above-mentioned constitution (5), the plate-shaped members are constituted of tapered members each of which includes a fluid passing passages on either one of or both lamination surfaces and has a thickness which is gradually increased toward the web floating surface from a side of the axis of the conveyance guide, and non-tapered members each of which has no fluid passing passages on lamination surfaces and has a fixed thickness, and

the conveyance guide is formed by radially arranging and laminating the tapered members and the non-tapered members with respect to an axis of the conveyance guide.

(7) In the method of manufacturing a web floating and conveying device having the above-mentioned constitution (5), the plate-shaped members are constituted of non-tapered members each of which includes fluid passing passages on either one of or both laminations surfaces and has a fixed thickness, and tapered members each of which has no fluid passing passages on lamination surfaces thereof and has a thickness which is gradually increased toward the web floating surface from a side of the axis of the conveyance guide, and

the conveyance guide is formed by radially arranging and laminating the non-tapered members and the tapered members with respect to an axis of the conveyance guide.

(8) In the method of manufacturing a web floating and conveying device having any one of the above-mentioned constitutions (5) to (7), the plate-shaped members of the conveying guide are made of brittle metal having elongation of 5% or less, and an edge surface of the plate-shaped member is formed into a bent shape by working such that a cylindrically curved web floating surface is formed by radially arranging the plate-shaped members with respect to the axis of conveyance guide.

### ADVANTAGEOUS EFFECTS OF THE INVENTION

According to the web floating and conveying device of the present invention, the cylindrically curved web floating surface is formed by radially arranging the plate-shaped members each of which includes the fluid passing passage with respect to the axis of the conveyance guide, and the fluid discharge holes on the rows of fluid discharge holes are not arranged on the same line in the circumferential direction of the conveyance guide. Accordingly, it is possible to impart a uniform floating force to the whole web conveying surface.

Further, a web floating amount can be made stable by discharging a uniform fluid along the conveying surface and hence, the web can be conveyed without causing the meandering of the web.

Further, when the web floating and conveying device of the present invention is used as a film stretching device, the temperature distribution of the film at the time of heat treatment can be made uniform and hence, a precise molecular orientation control can be realized in a film stretching step and a film drying step.

According to the method of manufacturing a web floating and conveying device of the present invention, the arcuate surface is formed by laminating the plate-shaped members each having a fluid passing passage and hence, the fluid passing passages can be arranged at desired positions in the axial direction of the device (film width wise direction) without using working such as laser working or drill working. Compared to hole forming working such as laser working or drill working, it is possible to easily form the fluid passing passage which has a small discharge cross-sectional area and large flow passage resistance (a ratio between a length of the fluid passing passage and a cross-sectional area of a fluid discharge port being large).

Further, when the web floating and conveying device of the present invention is used in the web conveyance, a fluid made of a gas such as compressed air or a processed gas or a liquid such as an aqueous solution, a processed liquid or water which is controlled under proper conditions is discharged from the web floating surface of the conveyance guide in the film widthwise direction as a floating and conveying fluid. Accordingly, a uniform fluid floating layer with no irregularities can be formed over the whole web floating surface. Particularly, the method exhibits the excellent quality maintaining property and reliability in the manufacture of a film which includes a stretching step at a glass transition temperature Tg or more of the film and a heat treatment step such as drying.

### BRIEF DESCRIPTION OF THE DRAWINGS

FIG. 1: A front view with a part broken away of a web floating and conveying device of an example 1, wherein a left portion of the web floating and conveying device is shown in cross section.

FIG. 2: A side view of the web floating and conveying device shown in FIG. 1.

FIG. 3: A cross-sectional explanatory view of the web floating and conveying device of the example 1 showing a web conveying state.

FIG. 4: A perspective view of a plate-shaped member which constitutes a conveyance guide where fluid passing passages are formed in one lamination surface in the web floating and conveying device of the example 1.

FIG. 5: A schematic side view showing a web floating and conveying device of an example 2, wherein a conveyance guide is constituted by radially combining and laminating tapered members and non-tapered members to each other.

FIG. 6: (a) is a perspective view showing the tapered member used in the conveyance guide of the example 2, and (b) is a perspective view showing the non-tempered member.

FIG. 7: An explanatory view for explaining a state before working showing one example of a method of manufacturing the web floating and conveying device of the example 2.

FIG. 8: An explanatory view showing a state after working in FIG. 7.

FIG. 9: A developed view for explaining a state of rows of fluid discharge holes formed in a web floating surface of the web floating and conveying device of the example 2.

### MODE FOR CARRYING OUT THE INVENTION

In a web floating and conveying device according to an embodiment 1, a conveyance guide is formed of a lamination-type assembled body of plate-shaped members which are radially arranged with respect to an axis of the conveyance guide (an axis of a cylinder which forms a cylindrically curved web floating surface), and fluid passing passages which form the fluid discharge holes by connecting the web floating surface and an introduction flow passage through which a pressurized fluid is supplied to each other are formed on either one or both lamination surfaces of the plate-shaped members which are arranged adjacent to each other.

The plate-shaped members are constituted of tapered members (wedge-shaped members) whose thickness is gradually increased toward a web floating surface side (outside) from a side of the axis of the conveyance guide.

Due to such a constitution, a discharge condition on a conveying fluid discharged from the fluid discharge holes can be properly set so that drawbacks such as stripe-shaped defects of a web which occur when the web is brought into contact with the conveyance guide and irregularities in film molecular orientation can be avoided thus providing the web floating and conveying device which has excellent web property maintaining property and excellent precision control property of the conveying fluid without causing quality defects.

The conveyance guide has an elongated columnar shape, and an upper surface of the conveyance guide is provided with the web floating surface having a so-called semi-cylindrical curved surface. By discharging a fluid formed of a gas such as compressed air or a process gas or a liquid such as an aqueous solution, process liquid or water from a large number of fluid discharge holes formed in the web floating surface by a predetermined arrangement, the web can be floated and conveyed.

As a shape of the web floating surface of the conveyance guide, depending on a shape of an edge surface of the plate-shaped member when the plate-shaped members are combined radially, besides a straight cylindrical shape, various shapes are considered including a cylindrical barrel shape where a center portion is raised (convex shape) and a hyperbolic body shape where a center portion is indented while both ends are raised (concave shape). By forming the shape of the web floating surface into a barrel shape or a hyperbolic body shape, a web wrinkle removing effect during conveyance can be expected.

A fluid supply part which supplies a pressurized fluid to the fluid discharge holes is arranged below the conveyance guide.

The plate-shaped members are elongated plate-shaped bodies having a small wall thickness which are arranged radially with respect to an axis of the elongated columnar conveyance guide, and upper edge surfaces of the plate-shaped members form the cylindrically curved web floating surface.

Fluid passing passages which extend from a fluid supply part side (axis) to a web floating surface side (outside) are formed on either one of or both lamination surfaces of the plate-shaped members, and the fluid passing passages connect the web floating surface and an introducing flow passage through which a pressurized fluid is supplied to each other. The fluid passing passage has a rectangular cross section of approximately 0.3 to 3 mm×0.05 to 1 mm or a semicircular cross section, for example. The fluid passing passage may have other polygonal cross section.

In a web floating and conveying device according to an embodiment 2, plate-shaped members are constituted of tapered members (wedge-shaped members) whose thickness is gradually increased toward a web floating surface side (outside) from a side of the axis of a conveyance guide and non-tapered members whose thickness is fixed, and the conveyance guide is formed such that the tapered members and the non-tapered members are arranged radially with respect to an axis of the conveyance guide thus forming the cylindrically curved web floating surface.

The conveyance guide of the web floating and conveying device can be constituted by combining and arranging the non-tapered members and the tapered members and hence, curved surface working of the web floating surface can be performed easily by performing curved surface working of edge surfaces after laminating a plurality of plate-shaped members whereby working cost can be reduced.

The non-tapered member is an elongated plate-shaped member having a fixed thickness, and the tapered member is an elongated plate-shaped member having a thickness thereof increased toward a web floating surface side from a fluid supply part side. As a material of the non-tapered member and the tapered member, metal materials such as stainless steel, steel, cast iron are named. Further, a high-strength resin material such as an engineering plastic material having high strength and high wear resistance is also named.

The fluid passing passages may be formed on either one of or both lamination surfaces of only the tapered member, may be formed on either one of or both lamination surfaces of only the non-tapered member, or may be formed on either one of or both lamination surfaces of the tapered member and the non-tapered member.

In a web floating and conveying device according to an embodiment 3, the fluid discharge holes form a plurality of rows of fluid discharge holes which are directed in the same direction as the axis of the conveyance guide, and the fluid discharge holes on the rows of fluid discharge holes which are arranged adjacent to each other are not arranged on the same line in the circumferential direction of the conveyance guide.

Due to such a constitution, the fluid discharge holes formed in the web floating surface of the conveyance guide are arranged more uniformly and hence, even when the web such as a film is inclined with respect to a conveying surface so that a floating amount is increased or decreased in the conveying widthwise direction, by adjusting the floating amount, the meandering of the film which occurs when film tension is small can be suppressed.

With respect to intervals of the fluid discharge holes in the row of fluid discharge holes, besides the equidistant intervals, a large number of fluid discharge holes may be formed in a center portion of the conveyance guide in the widthwise direction. In this case, a web wrinkle removing effect during conveyance can be expected.

Further, when the plate-members are arranged radially, there may be a case where a second plate-shaped member which has no fluid passing passages on lamination surfaces thereof is sandwiched between the plate-shaped members. Due to such a constitution, the fluid discharge holes on the web floating surface can be arranged more uniformly and hence, the web can be conveyed in a stable manner.

In a web floating and conveying device according to an embodiment 4, by forming the plate-shaped members of the conveyance guide using brittle metal having elongation of 5% or less, the cylindrically curved surface of the web floating surface can be worked in an arcuate shape by grinding or polishing.

Due to such a constitution, edge surfaces of the plate-shaped members which form the web floating surface can be efficiently formed by performing curved surface working such as grinding and polishing and hence, the conveyance guide which is excellent in assembling accuracy and durability can be economically manufactured.

As brittle metal, cast iron containing a predetermined amount of carbon (for example, FC200) can be used.

To consider a case where the elongation of brittle metal which is used for forming the plate-shaped member exceeds 5%, when the conveyance guide of the web floating and conveying device is formed of these plate-shaped members, the fluid discharge holes collapse due to the occurrence of burrs at the time of working during grinding or polishing of the cylindrically curved shape, and a step for processing the burrs takes time. Accordingly, brittle metal having elongation exceeding 5% is not desirable.

In a web floating and conveying device according to an embodiment 5, a web can be floated and conveyed by discharging a pressurized fluid from fluid discharge holes formed on a web floating surface of a conveyance guide.

Due to such a method, the web which is brought into contact with a film support surface can be supported in a stable manner by a pressurized fluid such as water or compressed air discharged from fluid discharge holes.

Further, even when the web is formed of a film having low glass transition temperature Tg at which the web is liable to be softened, by discharging such a controlled pressurized fluid, even when the film on the web floating surface is inclined, a floating amount can be made stable and hence, the film can be conveyed softly while suppressing the deformation of the film whereby it is possible to obviate the occurrence of quality defects by preventing stripe-shaped defects or deformation of a web product such as an optical film in appearance.

When the conveyance guide of the web floating and conveying device is used as a direction changing member in a case where the flow direction of a line is changed, a plurality of such conveyance guides may be provided at every line direction changing place.

Further, the fluid discharge holes arranged on the surface of the conveyance guide parallel to the axial direction are formed of the fluid passing passages and hence, no particular precise hole forming step or the like is necessary and hence, the conveyance guide can be easily manufactured using brittle metal such as cast iron, an alloy of aluminum or the like or a high-strength synthetic resin or the like.

Examples of the present invention are specifically explained in further detail hereinafter.

### EXAMPLE 1

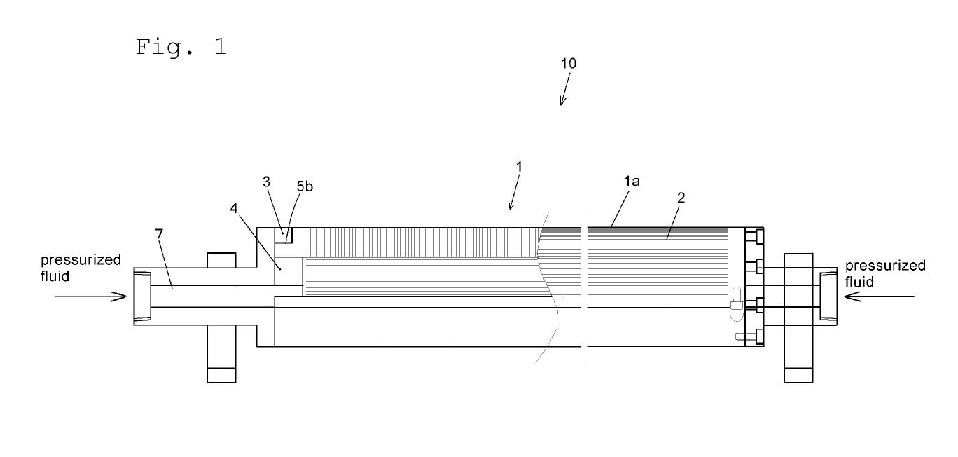

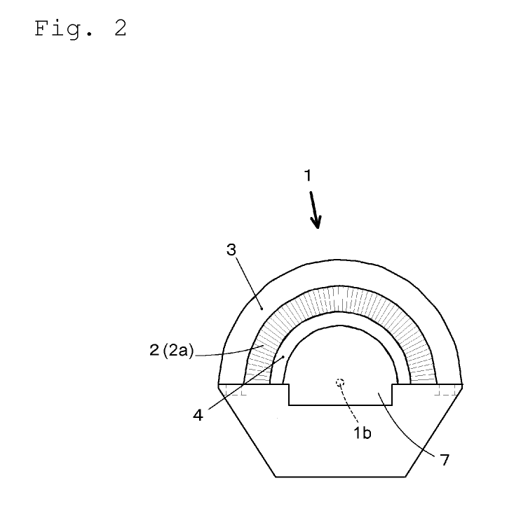

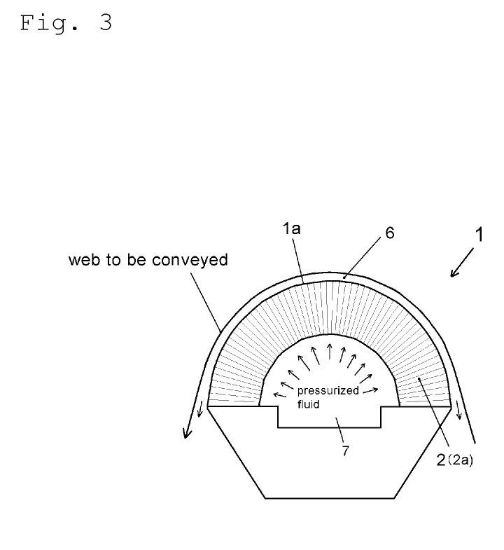

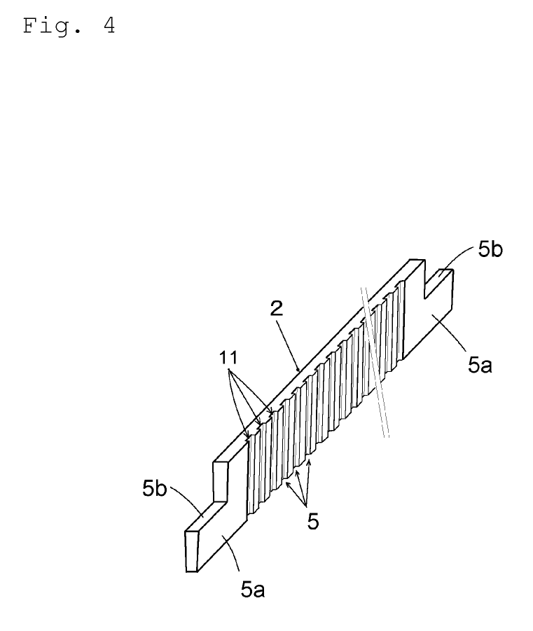

FIG. 1 is a front view with a part broken away of a web floating and conveying device of the example 1, wherein a left portion of the web floating and conveying device is shown in cross section, and FIG. 2 is a side view of the web floating and conveying device of the example 1. FIG. 3 is a cross-sectional explanatory view for explaining a web conveying state. FIG. 4 is a perspective view of a plate-shaped member which constitutes a conveyance guide where fluid passing passages are formed in one lamination surface.

The web floating and conveying device 10 of the example 1 includes a conveyance guide 1 which has a cylindrically curved web floating surface la on an upper surface side thereof. The conveyance guide 1 is constituted of a laminated assembly of plate-shaped members 2 which is formed by laminating tapered members 2a which are arranged radially about an axis 1b of the conveyance guide 1 thus forming a cylindrically curved web floating surface 1a. A stepped portion 5b is formed on both right and left end portions of each plate-shaped member 2 for fastening end surfaces of side portions of the plurality of plate-shaped members 2 thus forming the conveyance guide 1.

Further, the stepped portions 5b of the plate-shaped members 2 formed on both right and left ends of the plate-shaped members 2 are sandwiched and fixed by a fan-shaped holder 3 and a bearing portion 4 so that the plate-shaped members 2 are integrally fastened to each other thus constituting the conveyance guide 1.

As shown in FIG. 4, the tapered member 2a is formed such that fluid passing passages 5 are formed on one lamination surface of the plate-shaped member 2. The conveyance guide 1 is formed by radially assembling these tapered members 2a about the axis 1b, and the web floating surface la having a so-called semi-cylindrical curved shape is formed on an upper surface of the conveyance guide 1.

An introduction flow passage 7 through which a pressurized fluid is supplied to fluid discharge holes 11 is arranged on a lower portion of the conveyance guide 1, and a pressurized fluid such as compressed air is supplied to the hollow introduction flow passage 7 from a compressor or the like not shown in the drawing through the bearing portion 4.

Compressed air (pressurized fluid) for floating a web which is supplied from the bearing portion 4 through the introduction flow passage 7 passes through the fluid passing passages 5 formed on a lamination surface 5a of each tapered member 2a of the plate-shaped member 2, and is discharged from the fluid discharge holes 11 on the web floating surface la.

In this manner, as shown in FIG. 3, a fluid floating layer 6 for floating a web is formed on the web floating surface la which constitutes an upper portion of the conveyance guide 1 whose upper surface has a semi-cylindrical shape. Accordingly, it is possible to convey a web in a non-contact manner.

A blow-off amount of a fluid discharged from the fluid discharge holes 11 formed in the web floating surface la can be controlled to appropriate conditions corresponding to a size, a kind, a conveying speed and the like of a web to be conveyed using a control device which is provided separately.

For example, when the web is to be conveyed with a high tension, by setting a pressure of the fluid discharged from the fluid discharge holes 11 high, a web support pressure on the fluid floating layer 6 formed on the web floating surface la can be set high whereby the uniform web conveyance can be performed over the whole surface of the web.

Further, by setting the pressure of the fluid discharged from the fluid discharge holes 11 arranged at a center portion of the conveyance guide 1 in the widthwise direction high, it is possible to form the web to be conveyed into a barrel shape and hence, the generation of wrinkles on the web at the time of conveying the web can be prevented.

### EXAMPLE 2

Although a web floating and conveying device of the example 2 is substantially equal to the web floating and conveying device of the example 1, the web floating and conveying device of the example 2 differs from the web floating and conveying device of the example 1 with respect to the combination of plate-shaped members.

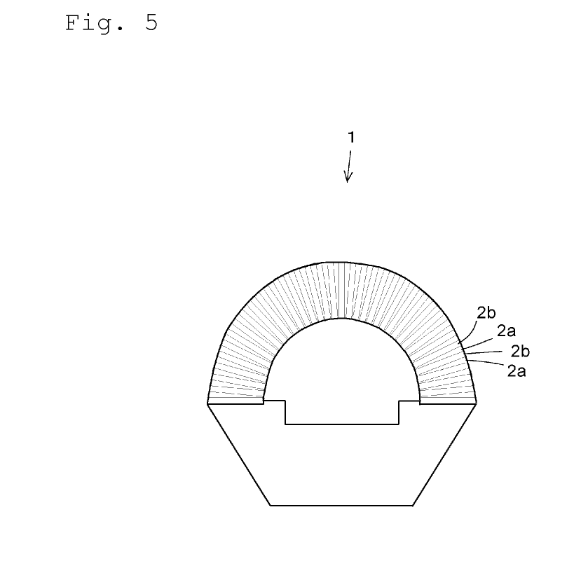

That is, a conveyance guide 1 of the web floating and conveying device of the example 2 is constituted by laminating, as shown in FIG. 5, tapered members 2a and non-tapered members 2b each of which has fluid passing passages 5 formed on both surfaces of a flat plate alternately in such a manner that the tapered member 2a and the non-tapered members 2b are radially combined to each other.

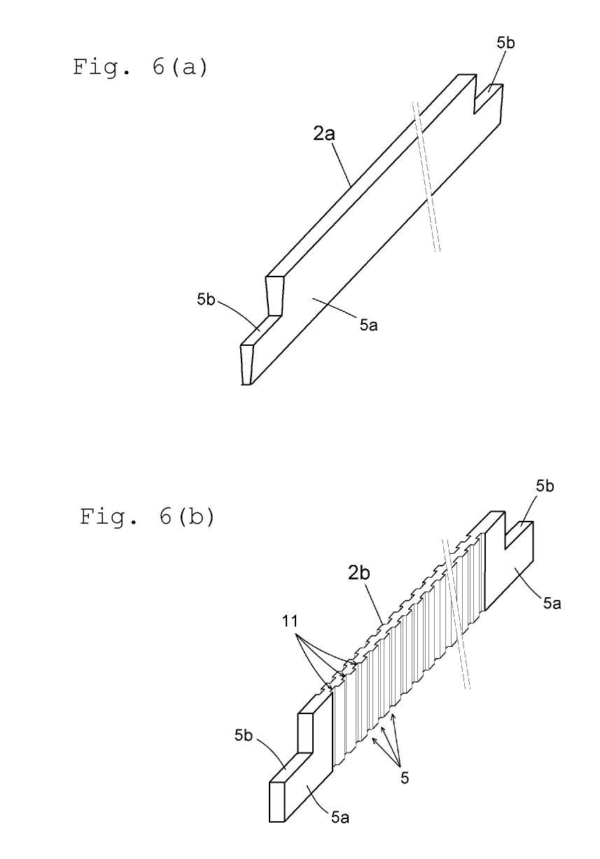

That is, the conveyance guide 1 of the web floating and conveying device of the example 2 is configured such that the tapered members 2a shown in FIG. 6 (a) and the non-tapered members 2b shown in FIG. 6 (b) each of which has the fluid passing passages 5 formed on both surfaces of the flat plate are alternately combined and laminated to each other.

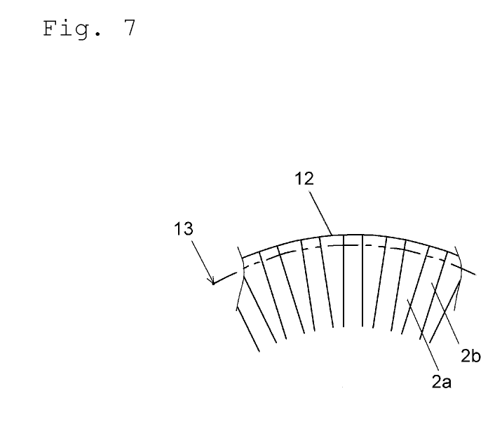

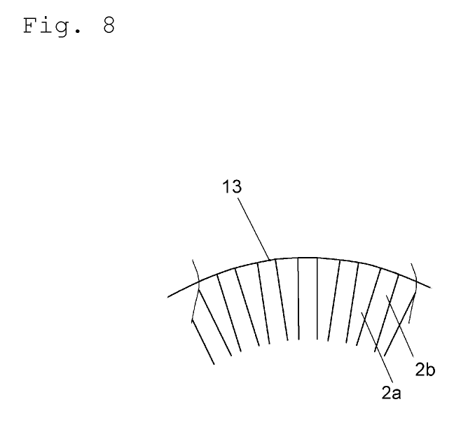

Next, one example of a manufacturing method of the web floating and conveying device of the example 2 is explained in conjunction with FIG. 7 and FIG. 8.

Firstly, the tapered members 2a and the non-tapered members 2b on each of which the fluid passing passages 5 are formed are radially laminated and combined to each other, and stepped portions 5b formed on both right and left ends of the tapered members 2a and the non-tapered members 2b are fastened to each other.

At this point of time, edge surfaces of the tapered member 2a and edge surfaces of the non-tapered members 2b (surfaces forming a web guide of the conveyance guide) have a polygonal shape. However, by applying working such as grinding or polishing to outer peripheral surfaces of the tapered members 2a and the non-tapered members 2b in a polygonal shape along an arcuate shape 13 indicated by a single chained line shown in FIG. 7 which shows a side of the conveyance guide 1, an arcuate shape 13 in a completed state indicated by a solid line in FIG. 8 is acquired.

In performing working such as grinding or polishing along the above-mentioned arcuate shape, depending on a material of the tapered members or a material of the non-tapered members, there may be a case where burrs are generated on the fluid discharge holes of the minute fluid passing passages by working and hence, the fluid discharge holes collapse whereby the post-treatment is additionally required. However, in this example, by using cast iron F200 which is brittle metal having elongation of 1% or less as a material for forming the plate-shaped member, it is possible to prevent the generation of burrs as effectively as possible. Further, by performing surface treatment using a copper brush or the like, it is possible to carry out the treatment for generated burrs.

As the rust prevention treatment, non-electrolytic nickel plating treatment is applied to the tapered members and the non-tapered members.

In the example 2, the fluid passing passages are formed on the non-tapered member and hence, the conveyance guide 1 can be easily manufactured whereby the manufacturing cost can be reduced.

### EXAMPLE 3

Although a web floating and conveying device of the example 3 is substantially equal to the web floating and conveying device of the example 1, the web floating and conveying device of the example 3 differs from the web floating and conveying device of the example 1 with respect to the arrangement of the fluid discharge holes formed on the web floating surface.

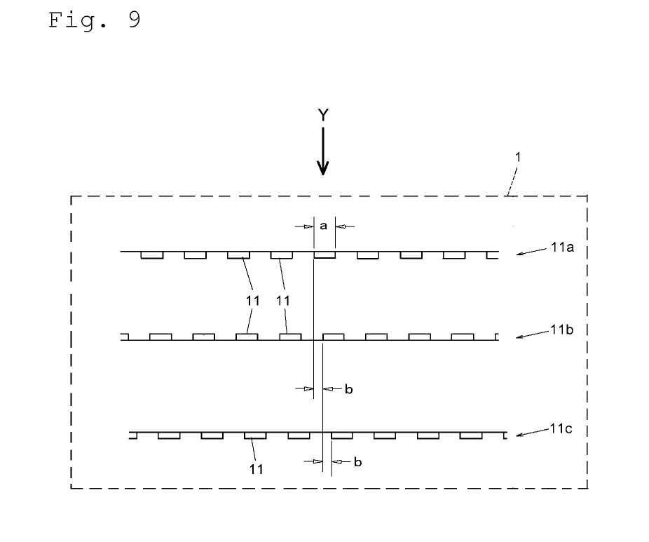

That is, as shown in a developed view of a web floating surface shown in FIG. 9, a plurality of fluid discharge holes 11 formed in the axial direction of a conveyance guide constitutes a row of fluid discharge holes 11a. With respect to the arrangement of the fluid discharge holes 11 in the rows of fluid discharge holes 11a, 11b, 11c which are arranged adjacent to each other, the fluid discharge holes 11 are not aligned in the circumferential direction (arrow Y) of the conveyance guide 1 and are displaced from each other by a size b respectively.

In this manner, by displacing the fluid discharge holes 11 in the circumferential direction (Y) by a range b which is smaller than a width of adjacent hole a, it is possible to float a web to be conveyed with a further uniform discharge fluid.

Particularly, the in-plane appearance, the thickness distribution and the molecular orientation distribution of a thermoplastic resin film which is subjected to high temperature processing at a glass transition temperature Tg or above can be made uniform.

Although the fluid discharge hole 11 shown in the drawing is has a quadrangular shape, the fluid discharge hole 11 may have a shape such as other polygonal shape or a circular shape.

### INDUSTRIAL APPLICABILITY

As has been explained theretofore, the gist of the present invention lies in that the web floating and conveying device of the present invention includes the conveyance guide which has the cylindrically curved web floating surface, and conveys the web in a floating state by discharging the pressurized fluid from fluid discharge holes formed in the web floating surface, wherein the conveyance guide is formed of the lamination-type assembled body of the plate-shaped members which are radially arranged with respect to an axis of the conveyance guide and form the cylindrically curved web floating surface, and the fluid passing passage which forms the fluid discharge hole by connecting the web floating surface and the introduction flow passage through which the pressurized fluid is supplied to each other is formed on either one or both lamination surfaces of the plate-shaped members which are arranged adjacent to each other. Accordingly, the uniform fluid floating layer can be formed over the whole surface of the web to be conveyed in the widthwise direction.

Further, also in a web stretching step at a glass transition temperature Tg or above and a heat treatment step such as drying, the web can be floated and conveyed without damaging a quality of the web and hence, the present invention has extremely high industrial applicability.

### DESCRIPTION OF REFERENCE NUMERALS AND SIGNS

1: conveyance guide
1a: web floating surface
1b: axis
2: plate-shaped member
2a: tapered member
2b: non-tapered member
3: holder
4: bearing
5: fluid passing passage
5a: lamination surface
5b: stepped portion
6: fluid floating layer
7: introduction flow passage
10: web floating and conveying device
11: fluid discharge hole
11a, 11b, 11c: row of fluid discharge holes
12: approximately arcuate shape
13: arcuate shape

1.-8. (canceled)

9. A web floating and conveying device which comprises a conveyance guide which has a cylindrically curved web floating surface, and conveys a web in a floating state by discharging a pressurized fluid from fluid discharge holes formed in the web floating surface, wherein
the conveyance guide is formed of a lamination-type assembled body of plate-shaped members which are radially arranged with respect to an axis of the conveyance guide and form the cylindrically curved web floating surface, and
fluid passing passages which form the fluid discharge holes by connecting the web floating surface and an introduction flow passage through which the pressurized fluid is supplied to each other are formed on either one or both lamination surfaces of the plate-shaped members which are arranged adjacent to each other.

10. The web floating and conveying device according to claim 9, wherein the plate-shaped members are constituted of tapered members whose thickness is gradually increased toward the web floating surface from a side of the axis of the conveyance guide, and non-tapered members whose thickness is fixed, and
the conveyance guide is formed of a lamination-type assembled body of plate-shaped members which form the cylindrically curved web floating surface by radially arranging the tapered members and the non-tapered members with respect to the axis of the conveyance guide.

11. The web floating and conveying device according to claim 9, wherein a second plate-shaped member having a lamination surface on which fluid passing passages are not formed is sandwiched between the plate-shaped members.

12. The web floating and conveying device according to claim 10, wherein a second plate-shaped member having a lamination surface on which fluid passing passages are not formed is sandwiched between the plate-shaped members.

13. The web floating and conveying device according to claim 9, wherein the fluid discharge holes form a plurality of rows of fluid discharge holes which are directed in the same direction as the axis of the conveyance guide, and the fluid discharge holes on the rows of fluid discharge holes which are arranged adjacent to each other are not arranged on the same line in the circumferential direction of the conveyance guide.

14. The web floating and conveying device according to claim 10, wherein the fluid discharge holes form a plurality of rows of fluid discharge holes which are directed in the same direction as the axis of the conveyance guide, and the fluid discharge holes on the rows of fluid discharge holes which are arranged adjacent to each other are not arranged on the same line in the circumferential direction of the conveyance guide.

15. The web floating and conveying device according to claim 11, wherein the fluid discharge holes form a plurality of rows of fluid discharge holes which are directed in the same direction as the axis of the conveyance guide, and the fluid discharge holes on the rows of fluid discharge holes which are arranged adjacent to each other are not arranged on the same line in the circumferential direction of the conveyance guide.

16. The web floating and conveying device according to claim 12, wherein the fluid discharge holes form a plurality of rows of fluid discharge holes which are directed in the same direction as the axis of the conveyance guide, and the fluid discharge holes on the rows of fluid discharge holes which are arranged adjacent to each other are not arranged on the same line in the circumferential direction of the conveyance guide.

17. A method of manufacturing a web floating and conveying device which comprises a conveyance guide which has a cylindrically curved web floating surface, and conveys a web in a floating state by discharging a pressurized fluid from fluid discharge holes formed in the web floating surface, wherein
the conveyance guide is formed in such a manner that plate-shaped members each of which is formed of a tapered member which includes fluid passing passages which form the fluid discharge holes by connecting the web floating surface and an introduction flow passage through which the pressurized fluid is supplied to each other on either one of or both lamination surfaces and gradually increases a thickness thereof toward the web floating surface from an axis side of the conveyance guide are radially arranged and are laminated to each other with respect to an axis of the conveyance guide.

18. The method of manufacturing a web floating and conveying device according to claim 17, wherein the plate-shaped members are constituted of tapered members each of which includes a fluid passing passages on either one of or both lamination surfaces and has a thickness which is gradually increased toward the web floating surface from a side of the axis of the conveyance guide, and non-tapered members each of which has no fluid passing passages on lamination surfaces and has a fixed thickness, and
the conveyance guide is formed by radially arranging and laminating the tapered members and the non-tapered members with respect to an axis of the conveyance guide.

19. The method of manufacturing a web floating and conveying device according to claim 17, wherein the plate-shaped members are constituted of non-tapered members each of which includes fluid passing passages on either one of or both laminations surfaces and has a fixed thickness, and tapered members each of which has no fluid passing passages on lamination surfaces thereof and has a thickness which is gradually increased toward the web floating surface from a side of the axis of the conveyance guide, and
the conveyance guide is formed by radially arranging and laminating the non-tapered members and the tapered members with respect to an axis of the conveyance guide.

20. The method of manufacturing a web floating and conveying device according to claim 17, wherein the plate-shaped members of the conveying guide are made of brittle metal having elongation of 5% or less, and an edge surface of the plate-shaped member is formed into a bent shape by working such that a cylindrically curved web floating surface is formed by radially arranging the plate-shaped members with respect to the axis of conveyance guide.

21. The method of manufacturing a web floating and conveying device according to claim 18, wherein the plate-shaped members of the conveying guide are made of brittle metal having elongation of 5% or less, and an edge surface of the plate-shaped member is formed into a bent shape by working such that a cylindrically curved web floating surface is formed by radially arranging the plate-shaped members with respect to the axis of conveyance guide.

22. The method of manufacturing a web floating and conveying device according to claim 19, wherein the plate-shaped members of the conveying guide are made of brittle metal having elongation of 5% or less, and an edge surface of the plate-shaped member is formed into a bent shape by working such that a cylindrically curved web floating surface is formed by radially arranging the plate-shaped members with respect to the axis of conveyance guide.
